(19) United States
(12) Patent Application Publication
(10) Pub. No.: US 2015/0285639 A1
(43) Pub. Date: Oct. 8, 2015

(54) METHOD AND SYSTEM FOR CROWD SENSING TO BE USED FOR AUTOMATIC SEMANTIC IDENTIFICATION

(71) Applicant: Umm-Al-Qura University, Makkah (SA)

(72) Inventors: Anas Basalamah, MAKKAH (SA); HEBA ALY, ALEXANDRIA (EG); Moustafa Amin Youssef, MAKKAH (EG)

(21) Appl. No.: 14/636,153

(22) Filed: Mar. 2, 2015

Related U.S. Application Data
(63) Continuation of application No. PCT/US14/33087, filed on Apr. 4, 2014.

(51) Int. Cl. G01C 21/26; H04W 4/02

(52) U.S. Cl. CPC G01C 21/26; H04W 4/023; H04W 4/027

(57) ABSTRACT

The Map++ as a system and method that leverages standard cell-phone sensors in a crowdsensing approach to automatically enrich digital maps with different road semantics like tunnels, bumps, bridges, footbridges, crosswalks, road capacity, among others is described. Our analysis shows that cell-phones sensors with humans in vehicles or walking get affected by the different road features, which can be mined to extend the features of both free and commercial mapping services. We present the design and implementation of Map++ and evaluate it in a large city. Our results show that we can detect the different semantics accurately with at most 3% false positive rate and 6% false negative rate for both vehicle and pedestrian-based features. Moreover, we show that Map++ has a small energy footprint on the cell-phones, highlighting its promise as a ubiquitous digital maps enriching service.

### CROSS REFERENCE TO RELATED APPLICATION

The instant application claims priority and is a continuation of PCT application PCT/US 14/33087 filed on Apr. 4, 2014. The pending PCT application is hereby incorporated by reference in its entireties for all of its teachings.

### FIELD OF TECHNOLOGY

A method and system for crowd sensing that is being used for automatic semantic identification that leverages standard cell-phone and smartphone sensors to automatically enrich digital maps with different road semantics. More specifically it relates to a method and system that defines a differentiation of analysis done on the data from sensors in smartphones for various activities.

### BACKGROUND

Recently, digital maps have gained great attention due to their high economic and social impact; they are integrated into our everyday lives in different forms such as navigation systems, traffic estimation services, location based services, asset tracking applications, and many more. Realizing the economic value of this technology, several giant companies are producing commercial map services including Google Map, Yahoo! Map, and Microsoft's Bing Map, as well as free services such as OpenStreetMaps. These map services attract millions of users daily. In 2013, Google announced that its Google Maps service is accessed by over one billion users every month.

Typically, these maps are constructed through satellite images, road surveyors, and/or manual entry by trained personnel. However, with the dynamic changes and richness of the physical world, it is hard to keep these digital maps up-to-date and capture all the physical world road semantics. To address this issue, commercial map companies started to provide tools, e.g. Google's MapMaker and Nokia's HERE Map Creator, for users to manually send feedback about their maps, i.e. crowd source the map updates. This was even generalized to build entire completely-free editable maps such as OpenStreetMap (OSM) and WikiMapia. However, these services require active user participation and are subject to intentional incorrect data entry by malicious users.

With the proliferation of today's sensor-rich mobile devices, cell phones are becoming the bridge between the physical and digital worlds. Researchers leveraged the GPS chips on smart phones to collect traces that can be used automatically to update existing maps and infer new roads. However, GPS is an energy hungry device and these systems focus only on estimating missing road segments. Today, all existing mapping services, both commercial and free, miss a large number of semantic features that are a necessity for many of today's map-based applications. There is a need for a better method and system to navigate and guide the users.

### SUMMARY

In the present disclosure, in one embodiment, a method and system called Map++ that leverages the ubiquitous sensors available in commodity cell-phones to automatically discover new map semantics to enrich digital maps. In another embodiment, a crowd sensing that is being used for automatic semantic identification that leverages standard cell-phone and smartphone sensors to automatically enrich digital maps with different road semantics such as tunnels, bumps, bridges, footbridges, crosswalks and road capacity. In one embodiment, a differentiation of analysis is done on the data from sensors in smartphones for various activities define from those who walk verses those who are in-vehicles. For example, navigation systems relay on important semantics to better guide users to their destinations; a short route may be falsely tempting if traffic lights are hidden from the user, a pedestrian tourist might be deceived when finding out that the road has no sidewalks, city evacuation planning might be ineffective if maps are not tagged with the number of lanes, a driver might be at risk of an accident if his map does not show the road bumps ahead, and a person with disability needs a map that shows the elevator-enabled subway stations. The instant invention overcomes all these shortcomings.

In one embodiment, as a system the Map++ architecture to automatically crowdsense and identify map semantics from available sensor readings without inferring any overhead on the user and with minimal energy consumption. In another embodiment, a framework for extracting the different map features from both pedestrian and in-vehicle traces is disclosed. In another embodiment, an implementation of Map++ method and system on Android device is done and an evaluation for its accuracy and energy-efficiency in a typical city is performed.

In one embodiment, the instant system and method depends only on time- and location-stamped inertial sensor measurements, which have a low-energy profile for both road semantics estimation and accurate localization, removing the need for the energy-hungry GPS. For example, a phone going inside a tunnel will experience a drop in the cellular signal strength. This can be leveraged to detect the tunnel location. Map++ uses a classifier-based approach based on the multi-modal phone sensor traces from inside cars to detect tunnels and other road semantics such as bridges, traffic calming devices (e.g. bumps, cat-eyes, etc.), railway crossings, stop signs, and traffic lights. In another embodiment, the system and method uses pedestrians' phone sensor traces to detect map semantics like underpasses (pedestrian tunnels), footbridges (pedestrian bridges), crosswalks, stairs, escalators, and number of lanes.

In one embodiment, Map++ system architecture as well as the details of its components are disclosed. In another embodiment, implementation of Map++ over different android phone is shown. It has been observed that detection of different map features was performed accurately by using android device resulting in 3% false positive rate and 6% false negative for in-vehicle traces, and 2% false positive rate and 3% false negative rate for pedestrian traces. In one embodiment, Map++ can detect the location of the detected features accurately to within 2 m using as few as 12 samples without using the GPS chip. This comes with a low power consumption of 23 mW, which is 50% less than GPS when run at a 1 minute duty cycle.

Other features will be apparent from the accompanying Figures and from the detailed description that follows.

### BRIEF DESCRIPTION OF THE DRAWINGS

Example embodiments are illustrated by way of example and no limitation in the graph and in the accompanying Figures, like references indicate similar elements and in which:

FIG. 1 is a diagram illustrating a map of Alexandria, Egypt as an example.

FIG. 2 depicts the Google maps in the past and that which is geographically specific to Egypt.

FIG. 3 provides a map from Open Street maps that is generally used for development purposes.

FIG. 4 shows that both commercial and free mapping services miss a number of semantic features for the next generation maps.

FIG. 5 shows the Map++ System architecture.

FIG. 6 shows the decision tree classifier for detecting map features from pedestrian traces.

FIG. 7 shows the effect of walking through an underpass on the cell-phone sensors measurements.

FIG. 8 shows the start and end tunnel through which pedestrians walk.

FIG. 9 shows the step pattern while walking verses the step pattern when going down stairs.

FIG. 10 compares the variance in acceleration and the steps frequency while walking to when going down on the stairs.

FIG. 11 illustrates the variance of acceleration and ambient magnetic field while being stationary, walking and using the escalator.

FIG. 12 shows acceleration variance when going up then walking on the foot bridge then going down the stairs.

FIG. 13 shows the decision tree classifier for detecting different map features from in-vehicle traces.

FIG. 14 shows the effect of going inside a tunnel on the cell-phone sensors measurements.

FIG. 15 shows the effect of the different map features on the Y-axis gravity acceleration.

FIG. 16 shows the effect of different traffic calming devices on the X, Y and Z gravity acceleration variance in comparison with smooth road and railway crossing.

FIG. 17 illustrates the difference between a roundabout and an intersection in terms of a car behavior.

FIG. 18 shows that moving along the curve, the car orientation changes till the end of the curve, where the car returns to its original direction. This is unlike taking a turn, where direction changes after the end of the curving part.

FIG. 19 shows the effect of samples on the accuracy of estimating the semantic location.

FIG. 20 shows the energy footprint of Map++ as compared to the systems that use GPS with different duty cycles.

FIG. 21 is a diagrammatic system view of a computer device view in which any of the embodiments disclosed herein may be performed, according to one embodiment.

FIG. 22 shows an entire system for processing MAP++ system and method, according to one or more embodiments.

Other features of the present embodiments will be apparent from the accompanying detailed description that follows.

### DETAILED DESCRIPTION

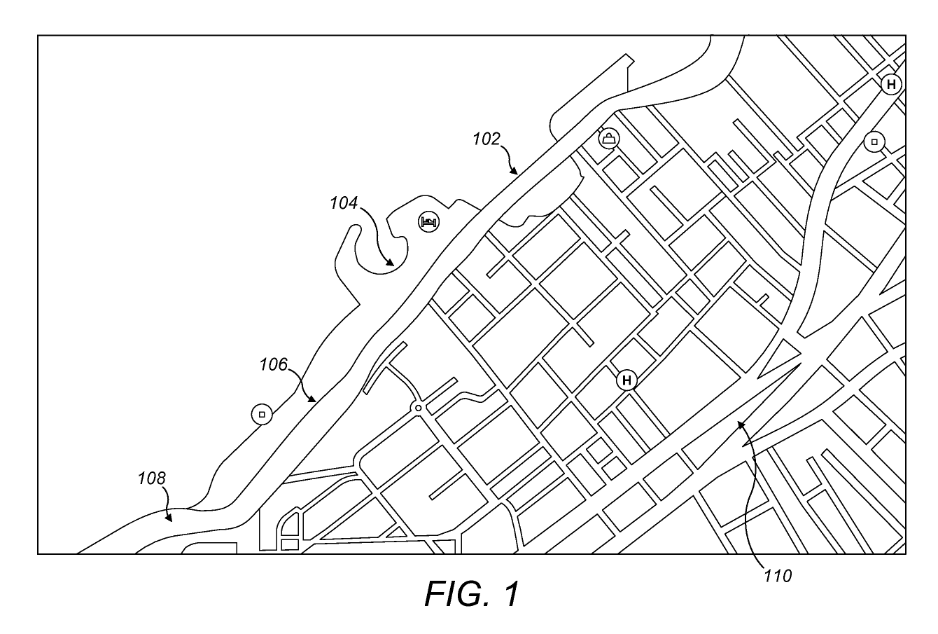

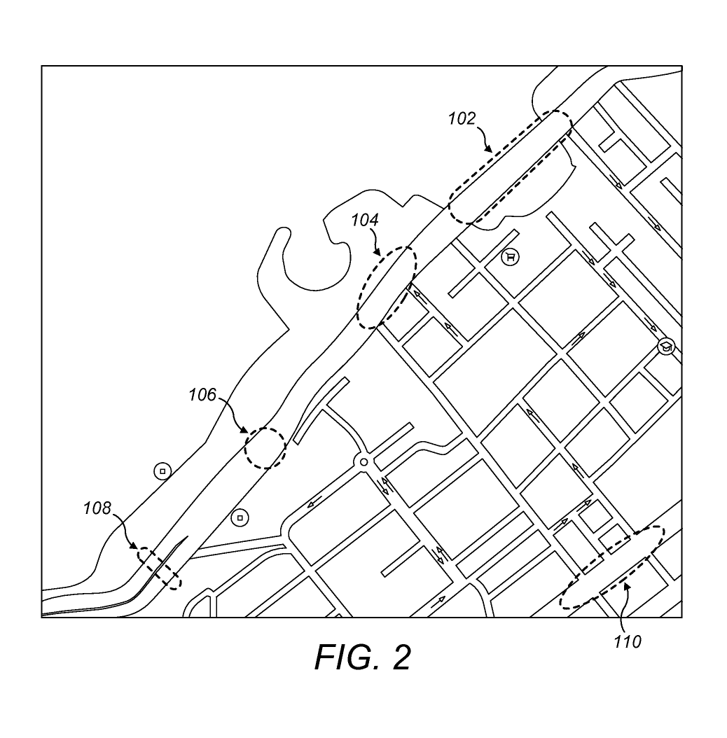

The present disclosure relates to a method and system for crowd sensing that is being used for automatic semantic identification that leverages standard cell-phone and smartphone sensors to automatically enrich digital maps with different road semantics. FIG. 1 shows the map of Alexandria that is displayed by Google Maps today that is recent. It can be seen that a bridge 102, a traffic section calming 104, multiple lanes 106, an underpass 108 and traffic signs 110 are missed. FIG. 2 shows the map that with road features normally ignored by the popular map applications such as Google Maps. These features are very useful for people travelling that need extra assistance.

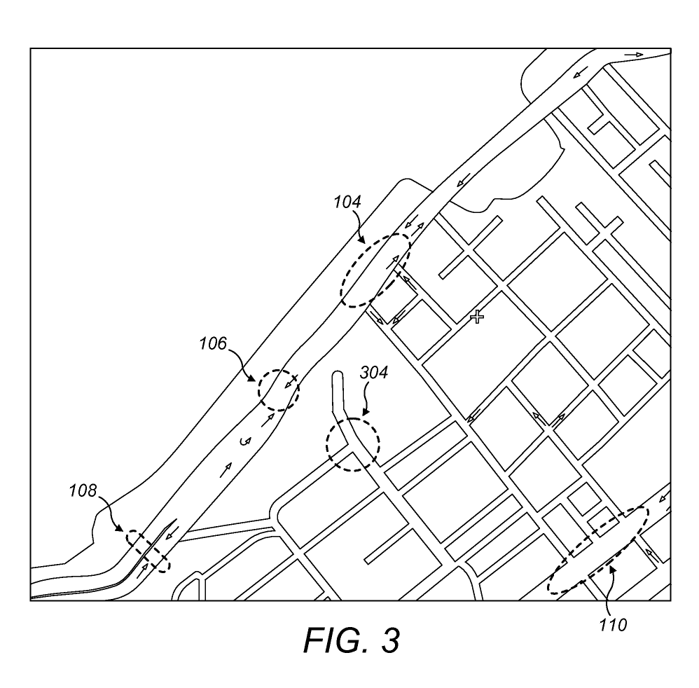

FIG. 3 shows that Open Street Maps, the genesis for many map applications, also do not provide complete information. We see that 302 is identified as bridge, but others such as multiple lanes 104 and underpass 106 is missing.

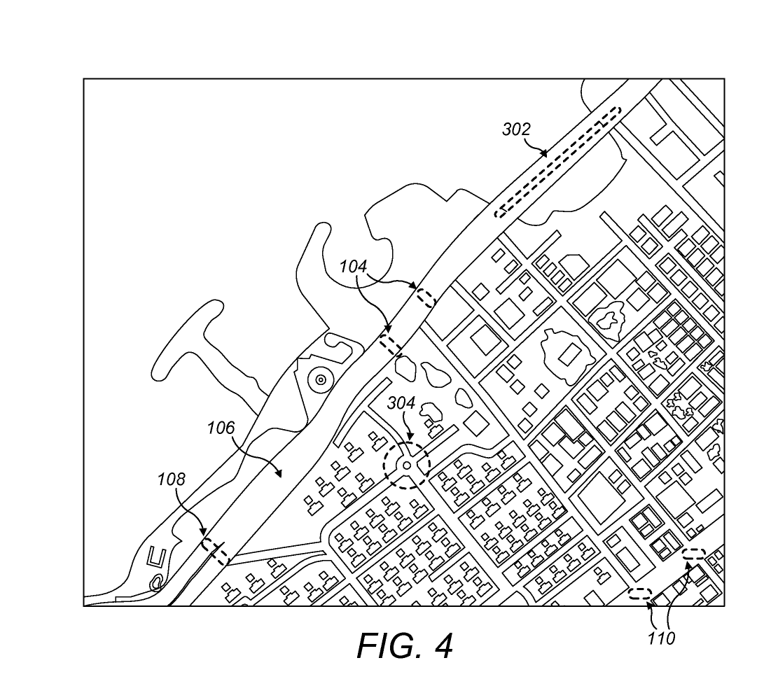

FIG. 4 shows the satellite image of view by the proposed system Map++. It can be clearly seen that the details ignored by popular map applications are indeed covered in Map++. For example, the bridge 302 is clearly identified. Similarly, a roundabout 304, an underpass 108 and multiple lanes 106 are properly identified.

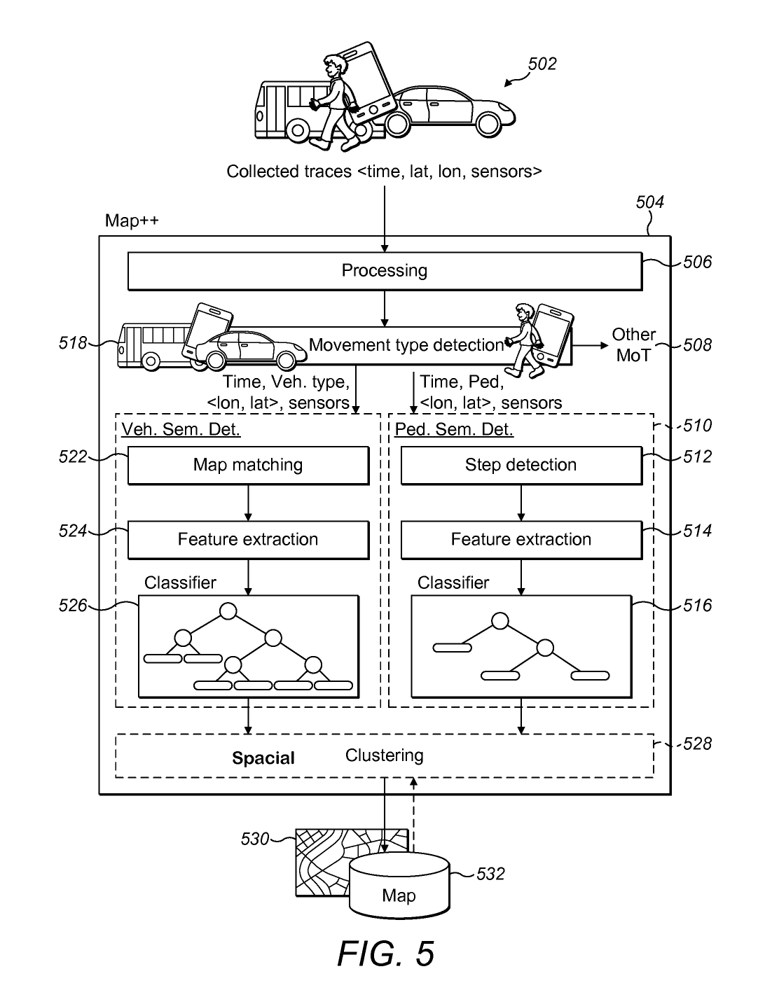

FIG. 5 shows the Map++ system architecture. Map++ is based on a crowdsensing approach, where cell phones carried by users submit their data to the Map++ service running in the cloud in a way transparent to the user. The data is first processed by Map++ to reduce the noise. Then, the user mode of transportation is inferred to separate pedestrian and in-vehicle traces from other modes of transportation. Map++ has two core components: one for extracting map features from in-vehicle traces and the other for extracting the map features from pedestrian traces. Map++ takes a classifier approach to determine the different road semantics based on extracted features from the collected sensor traces.

Traces information data Collection: The trace information data collection module 502 collects time-stamped and location-stamped traces along with sensor measurements. These include available inertial sensors (such as accelerometer, gyroscope and magnetometer) as well as cellular network information (associated cell tower ID and its Received Signal Strength Information (RSSI), plus neighboring cell towers and their associated RSSI). These sensors have a low cost energy profile and they are already running all the time during the standard phone operation to maintain cellular connectivity or to detect phone orientation changes. Therefore, using them consumes zero extra energy.

To get the location information, Map++ is generic enough to either use GPS coordinates or other energy efficient localization systems such as Dejavu (a system and method for location calculation) that can provide accuracy better than GPS in urban conditions with much lower energy consumption. To achieve this, Dejavu uses a dead-reckoning approach based on the low-energy phone inertial sensors. However, to reduce the accumulated error in dead-reckoning, Dejavu leverages the ample unique physical and logical landmarks in the environments; such as turns, curves, and cellular signal anomalies; as error resetting opportunities. Dejavu can achieve a median distance error of 8.4 m in in-city driving conditions and 16.6 m in highway driving conditions with a 347.4% enhancement in energy consumption compared to the GPS. Therefore in the performance measurement, Map++ energy efficiency is based on Dejavu's energy-efficient localization and using the inertial and cellular sensors information for its analysis. The Map++ architecture is encompassed in 504 that takes the collected traces and processes to obtain quality data on the road characteristics

Preprocessing: The first module to receive the traces is the Preprocessing 506 module. This module is responsible for preprocessing the raw data collected from raw sensor measurements to reduce the effect of (a) phone orientation changes and (b) noise and bogus changes, e.g. sudden breaks, or small changes in the direction while moving. To handle the former, we transform the sensor readings from the mobile coordinate system to the world coordinate system leveraging the inertial sensors. To address the latter, we apply a low-pass filter to the raw sensors data using local weighted regression to smooth the data.

Transportation Mode Detection: Based on the preprocessing the mode of transportation is detected 508. Map++ is designed to detect two main classes of map semantics; in-vehicle and pedestrian as well as to filter other classes, such as train traces. We start by filtering users inside buildings. Different approaches have been proposed in literature based on the different phone sensors. Map++ uses the IODetector approach due to its accuracy and low-energy profile.

Similarly, transportation mode detection using the transportation mode detection module for outdoor users has been thoroughly studied in the literature. In the instant method and system provides the data collection which provides high accuracy of differentiation between the different transportation modes based on the energy-efficient inertial sensors. The technique starts by segmenting the location traces using velocity and acceleration upper bounds. Then the following features are used to classify each segment: The stopping rate, the heading and velocity change rate, the segment length, the nth maximum velocity and acceleration, average velocity, and velocity variance. A decision tree classifier 516, 526 is applied to identify the transportation mode for each segment.

Once the mode of transportation is detected, an HMM map matcher is applied to the in-vehicle traces to map the estimated locations to the road network to reduce the localization error 512, 522. Similarly, the UPTIME step detection algorithm that takes into account the different users' profiles and gaits is applied to the pedestrian acceleration signal to detect the user steps. In both cases, features are extracted 514, 524 from the traces to prepare for the road semantic classification step.

Map Semantics Extraction: There are a large number of road semantic features that can be identified based on their unique signature on the different phone sensors. Map++ uses a tree-based classifier 516, 526 to identify the different semantics.

Road Semantic Features Location Estimation: Whenever a road semantic feature is detected by the semantic detection modules (in-vehicle or pedestrians), Map++ determines whether it is a new instance of the road feature or not in addition to its location. To do this, Map++ applies spatial clustering 528 for each type of the extracted semantics. It uses density-based clustering algorithms (DBSCAN). DBSCAN has several advantages as the number of clusters is not required before carrying out clustering; the detected clusters can be represented in an arbitrary shape; and outliers can be detected. The resulting clusters represent map features.

The location of the newly discovered semantics is the weighted mean of the points inside their clusters. We weight the different locations based on their accuracy reported by Dejavu: In Dejavu, the longer the user trace from the last resetting point, the higher the error in the trace. Therefore, shorter traces have better accuracy. When a new semantic is discovered, if there is a discovered map feature within its neighborhood, we add it to the cluster and update its location. Otherwise, a new cluster is created to represent the new road feature. To reduce outliers, a semantic is not physically added to the map until the cluster size reaches a certain threshold.

Sensor specifications are different from one phone manufacturer to another, which leads to different sensor readings for the same map feature. To address this issue, Map++ applies a number of techniques including use of scale-independent features (e.g. peak of acceleration) and combining a number of features for detecting the same semantic feature. Map++ does not also require real-time sensor data collection; it can store the different sensor measurements and opportunistically upload them to the cloud for processing; allowing it to save both communication energy and cost.

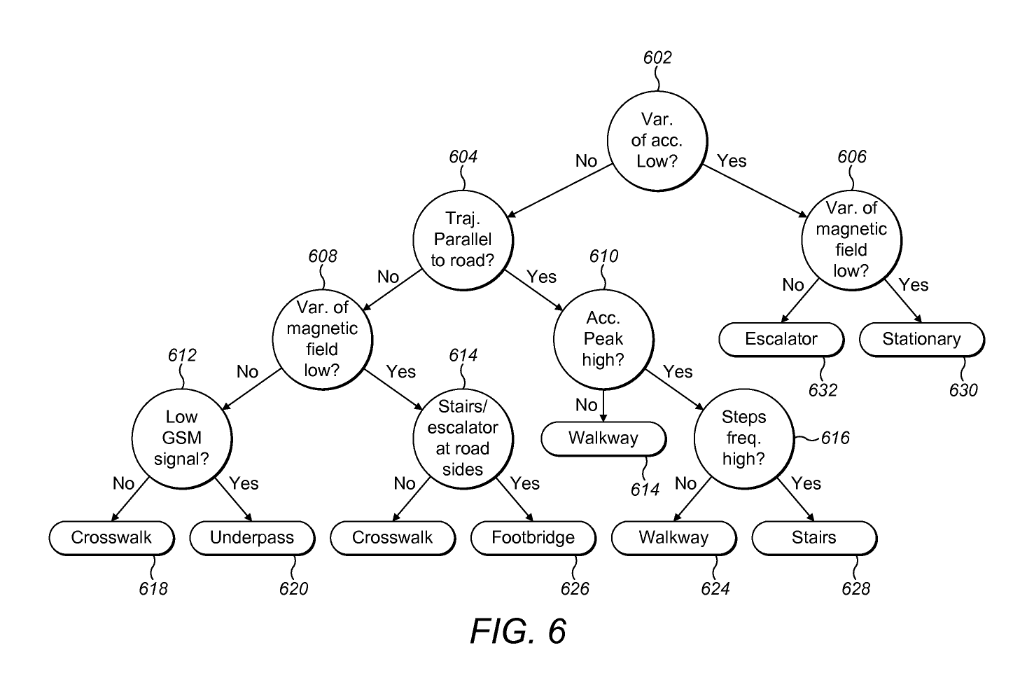

Pedestrian traces semantic detection module 510: To determine the different road semantics, Map++ applies a decision tree classifier to the extracted features from the pedestrian traces. FIG. 6 shows the decision tree classifier used to extract the different semantic map features from the pedestrian traces. We give the details of the classifier features that can differentiate the different semantic road features (Crosswalk 618, Underpasses 620, Footbridge 626, Walkway 624, Stairs 628, Escalator 632, Stationary 630 and number of lanes).

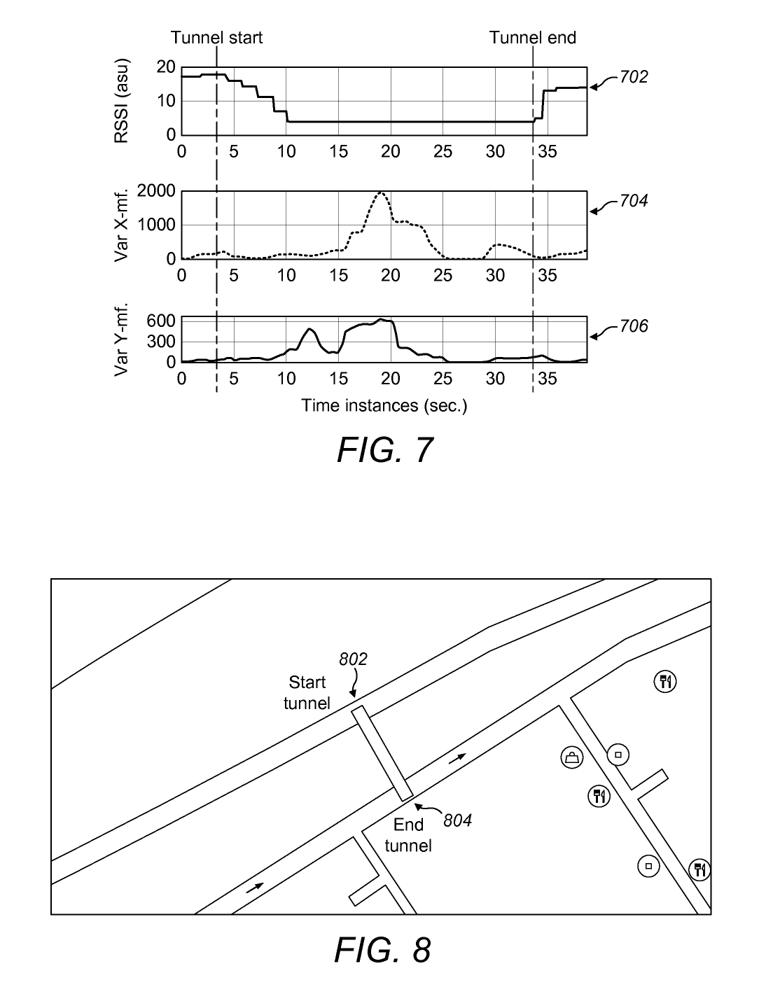

Underpasses or pedestrian tunnels are specially constructed for pedestrians beneath a road or railway, allowing them to reach the other side. A pedestrian trace crossing a road may be a crosswalk (e.g. zebra lines), a bridge, or an underpass. We identify the underpasses from other classes by their unique features: Walking inside an underpass, a cell-phone will experience a drop in the cellular signal 702 and also a high variance in the magnetic field around it (both Y 706 and X 704 axes) due to metals and electricity lines inside the tunnel as shown in FIG. 7. We can see a real example of the underpass in Alexandria depicted in FIG. 8, where the measurement started in 802 and ended in 804.

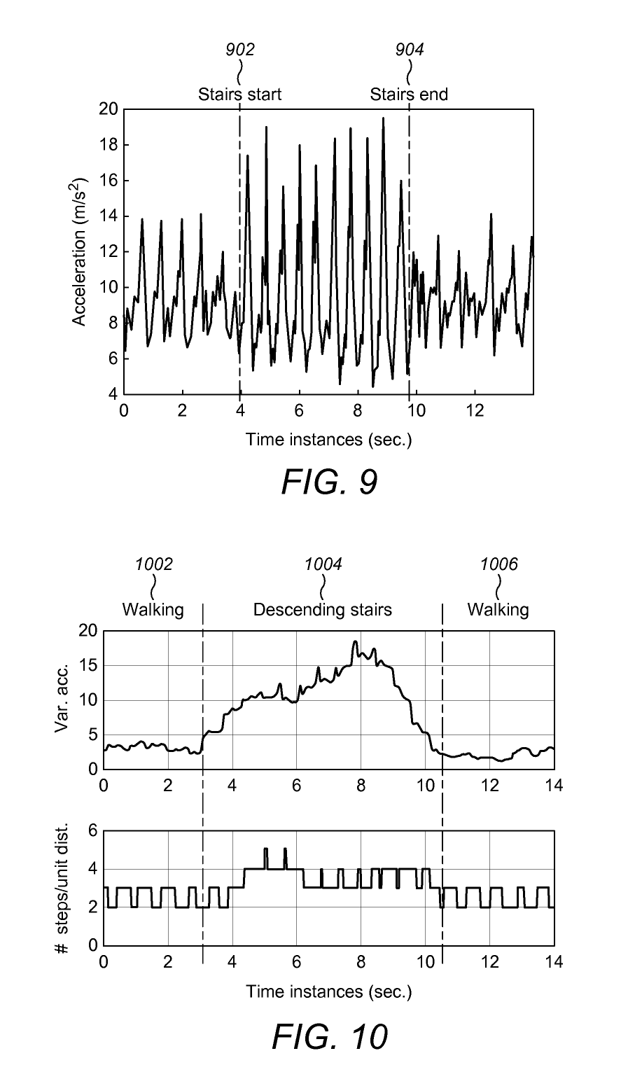

Furthermore, when ascending or descending stairs, the frequency of steps, detected by a simple peak detector (FIG. 9), within the unit distance increases since the user is moving vertically (FIG. 10). The start of the peak and end of peak can be measured and correlated to Stairs Start 902 and Stairs End 904.

FIG. 10 illustrates the effect of walking and going down on stairs on the acceleration variance and the steps frequency. When descending stairs, the gravity force affecting the person will lead to a higher peak in acceleration, and hence higher variance 1004, as compared to walking 1002, 1006. The number of steps can be used, e.g., to determine the height of the pedestrian bridge, which is useful for determining the height limits for the vehicles on the road.

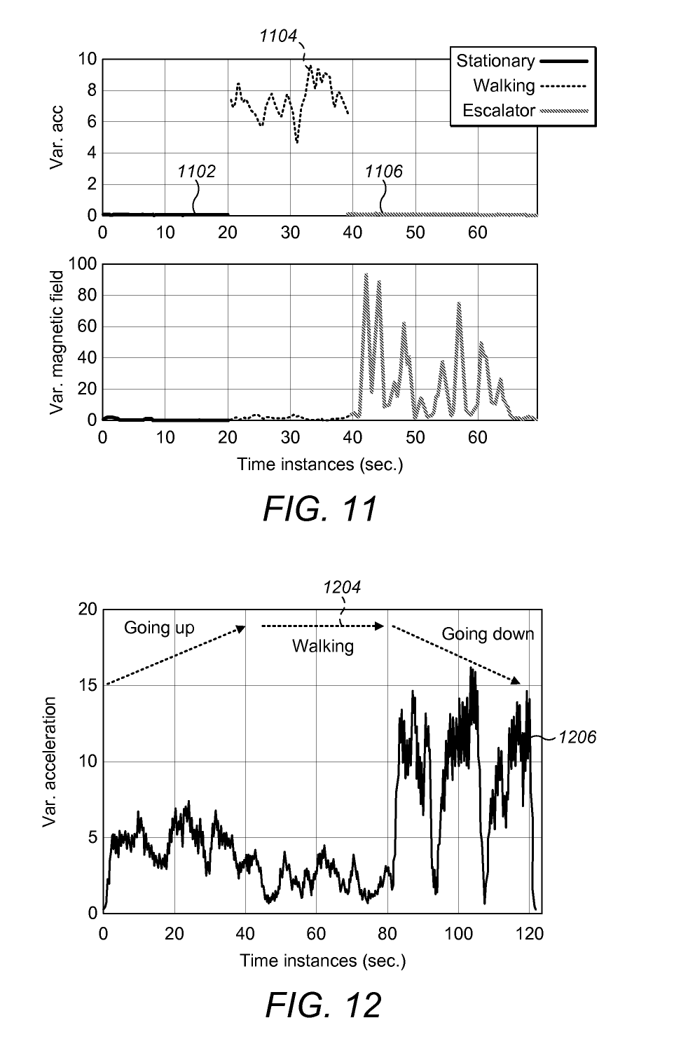

FIG. 11 illustrates the variance of acceleration and ambient magnetic field while being stationary 1102, walking 1104 and using Escalator 1106. When using escalators, users typically keep standing while carried by the moving staircase. Therefore, the acceleration variance remains small compared to walking. However, escalators are often powered by constant-speed alternating current motors, which results in high variance in the magnetic field.

FIG. 12 illustrates the acceleration variance when going up then walking on the footbridge then going down on stairs. Similar to underpasses, footbridges allows pedestrians to safely cross roads, railways and rivers. A user crossing a footbridge will use stairs/escalators to ascend 1202 and descend 1206. In between, the user will walk 1204 the length of the footbridge. We separate footbridges from crossroads by detecting the stairs/escalator pattern before/after using them; we separate them from underpasses using the cellular signal which drops in the underpasses case but not in the footbridge case. Similar to others, crosswalks 618 and number of lanes can be detected from pedestrian traces. The number of lanes is detected using the ratio between road width and average lane width.

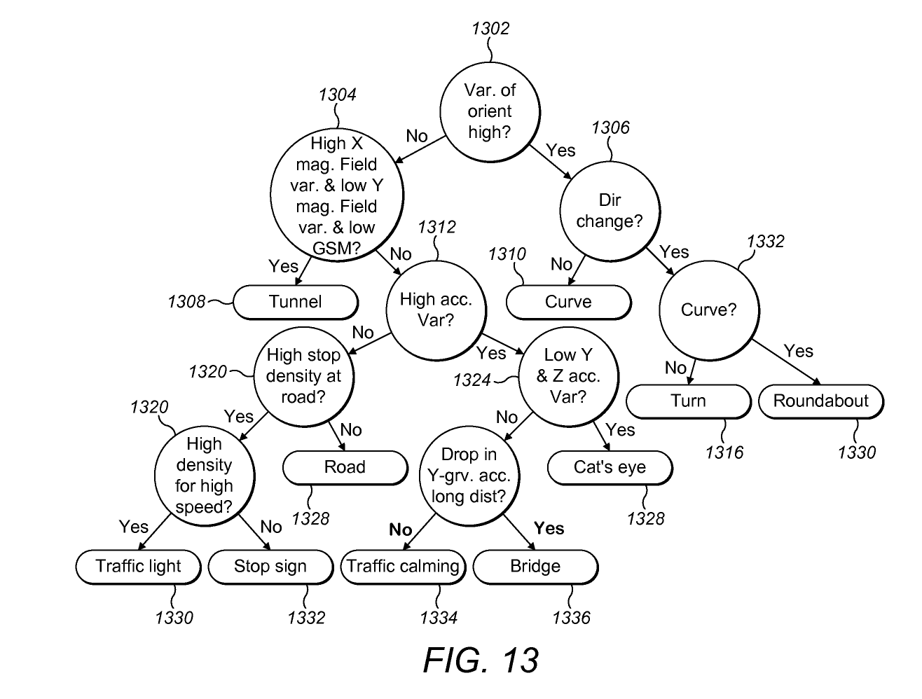

In-vehicle traces semantic detection module 520: We extract the different map semantic features from the traces collected by the in-vehicle users. FIG. 13, shows the tree classifier used to detect the different semantics. Based on the rules 1302 on orientation, magnetic variance 1304, direction changes 1306, high acceleration variance 1312, Curves 1332, high stop density 1320, low acceleration variances 1324, gravity acceleration sensor 1326 and high density sensors 1318, we can deduce if it is a Tunnel 1308, Curve 1310, Turn 1316, Roundabout 1330, Road 1328, Cat's eye 1328, Traffic light 1330, Stop sign 1332, Traffic calming 1334 and Bridge 1336.

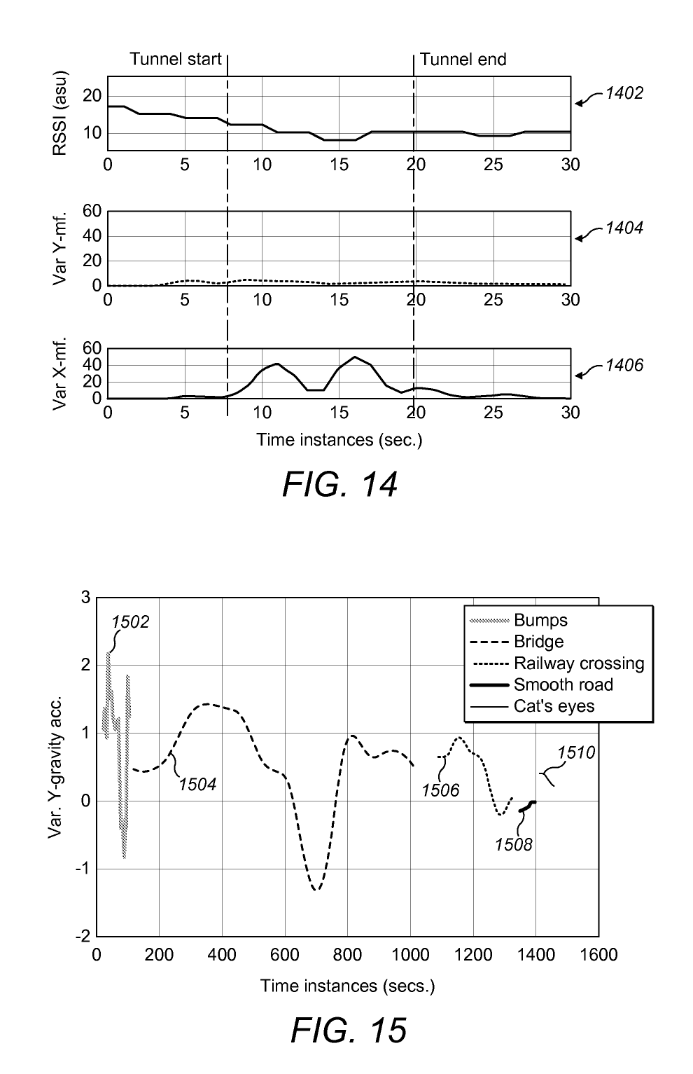

Similar to the underpass case in pedestrian walk, a car going inside a tunnel will typically experience an attenuated cellular signal 1402. We also notice a large variance in the ambient magnetic field in the x-direction 1406 (perpendicular to the car direction of motion) while the car is inside the tunnel. This is different from the underpass case, where there is no smooth ramp at the end and hence both the x and y magnetic fields are affected. Therefore, car tunnels have a low variance in the y-axis (direction of car motion) magnetic field 1404 as shown in FIG. 14.

FIG. 15 shows the effect of the different map features on the Y-axis gravity acceleration. Bridges cause the car to go up at the start of the bridge and then go down at the end of the bridge. This is reflected on the Y-gravity or Z-gravity acceleration. Although other classes, such as bumps 1502, cause the same effect (Y or Z gravity acceleration going up then down), bridges 1504 are unique in having this effect over a longer distance. The bridge is detected at its end. Note that after detecting the end of the bridge, we could identify its starting point.

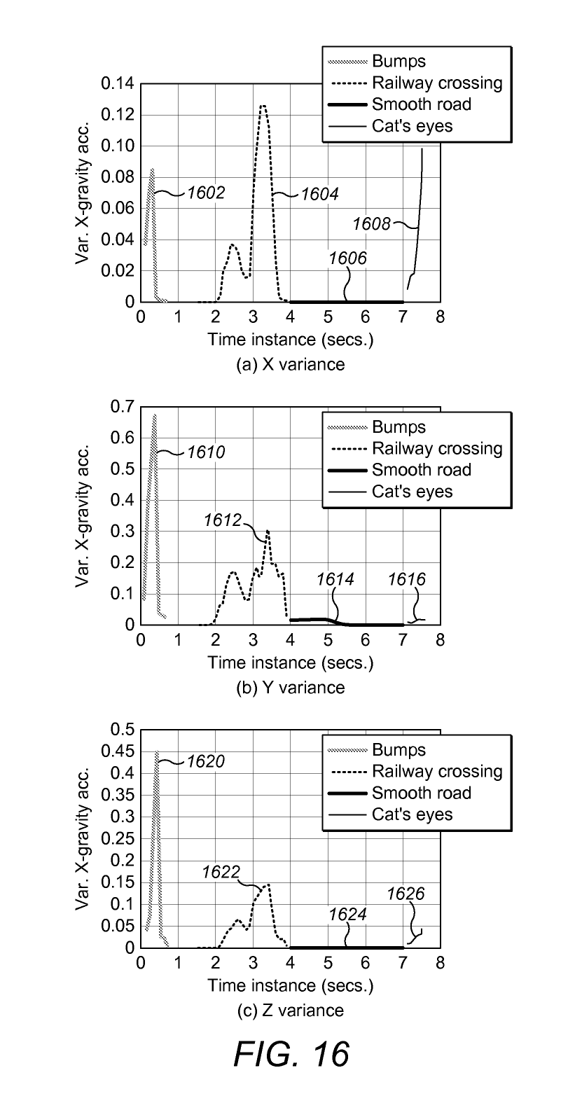

FIG. 16 shows the effect of different traffic calming devices on the X, Y, and Z gravity acceleration variance in compared with smooth road and railway crossing. Different traffic calming techniques like bumps, speed humps, and cat's eyes 1510 all cause the car to move up then down similar to bridges, affecting all gravity acceleration axes. However, unlike bridges, all these classes affect the gravity acceleration over a small distance. Cat's eyes have the lowest Y and Z variance; bumps have the highest Y and Z variance. To further separate these classes, we employ other sensors.

Vertical deflection devices (e.g., speed bumps, humps, cushions, and speed tables): As the vehicle hits such devices, large spikes in variance in the Y-axis 1610 and Z-axis 1620 gravity acceleration are sensed compared to the other classes while in motion. Unlike other road anomalies, the cat's eyes structure does not cause the car moving above them to have high variance in the Y-axis 1616 or Z-axis 1626 gravity acceleration. Railway crossings leads to a medium variance in the Y-axis 1612 and Z-axis 1622 gravity acceleration over a longer distance compared to other road anomalies. In addition, they cross a railway if available on the map.

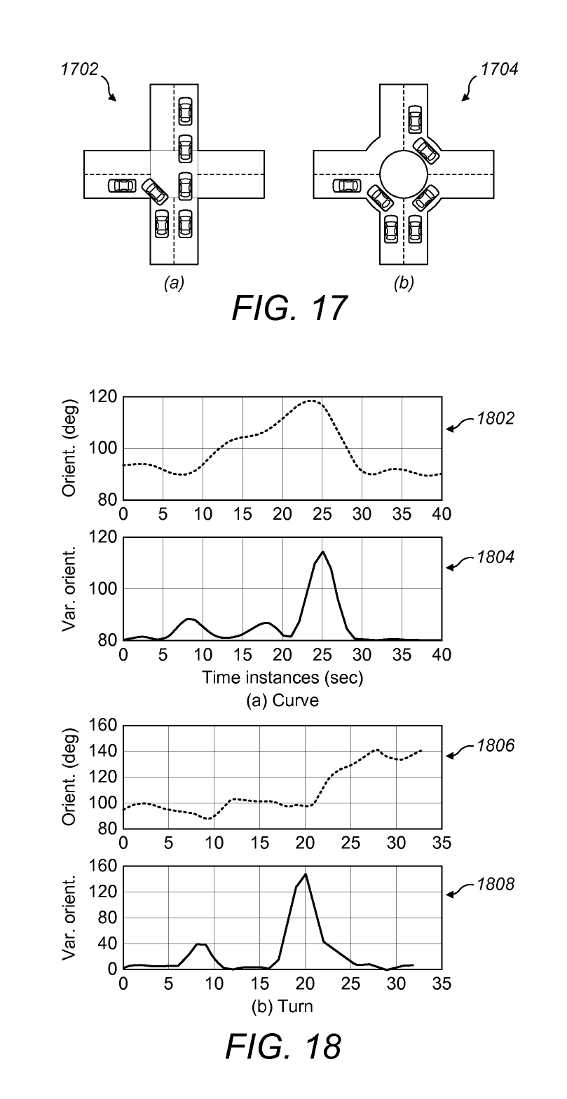

A roundabout is a type of circular junction in which road traffic must travel in one direction around a central island. While a four-way intersection are typically two perpendiculars crossing roads (FIG. 17). Roundabouts 1704 can be identified as normal crossings by some commercial services as shown in FIG. 4. Noting that a four-way intersection will only have sharp 90 degrees turns 1702; while a roundabout 1704 will have both turns and curves (FIG. 17), we can leverage the orientation angle sensor to identify the roundabouts by the differences between their start and end orientation angles. FIG. 18 clearly shows the difference between roundabout and an intersection in terms of car behavior.

Road Features Detection Accuracy: Tables I and II show the confusion matrices for detecting the different map semantics from in-vehicle and pedestrian traces, respectively. The tables show that different map features could be detected with small false positive and negative rates due to their unique signatures; we can detect the map semantics accurately with 3% false positive rate and 6% false negative rate from in-vehicle traces, and 2% false positive rate and 3% false negative rate from pedestrian traces.

TABLE I
CONFUSION MATRIX FOR CLASSIFYING DIFFERENT ROAD
SEMANTICS DISCOVERED FROM IN VEHICLE TRACES.

| | Cat's eyes | Bumps | Curves | Rail cross. | Bridges | Tunnels | Turns | unclass. | FP | FN | Total |
|---|---|---|---|---|---|---|---|---|---|---|---|
| Cat's eyes | 22 | 0 | 0 | 0 | 0 | 0 | 0 | 5 | 0 | 0.18 | 27 |
| Bumps | 0 | 30 | 0 | 3 | 0 | 0 | 0 | 0 | 0.03 | 0.09 | 33 |
| Curves | 0 | 0 | 20 | 0 | 0 | 0 | 0 | 0 | 0 | 0 | 20 |
| Rail cross. | 0 | 1 | 0 | 13 | 0 | 0 | 0 | 0 | 0.21 | 0.07 | 14 |
| Bridges | 0 | 0 | 0 | 0 | 9 | 0 | 0 | 1 | 0 | 0.1 | 10 |
| Tunnels | 0 | 0 | 0 | 0 | 0 | 11 | 0 | 0 | 0 | 0 | 11 |
| Turns | 0 | 0 | 0 | 0 | 0 | 0 | 41 | 0 | 0 | 0 | 41 |
| Overall | | | | | | | | | 0.03 | 0.06 | 156 |

TABLE II
CONFUSION MATRIX FOR CLASSIFYING DIFFERENT ROAD
SEMANTICS DISCOVERED FROM PEDESTRIAN TRACES.

| | Underpass | Stairs | Escalator | Footbridge | Walking | Stationary | Crosswalk | FP | FN | Σ |
|---|---|---|---|---|---|---|---|---|---|---|
| Underpass | 11 | 0 | 0 | 0 | 0 | 0 | 0 | 0 | 0 | 11 |
| Stairs | 0 | 14 | 0 | 0 | 2 | 0 | 0 | 0 | 0.13 | 16 |
| Escalator | 0 | 0 | 15 | 0 | 0 | 0 | 0 | 0 | 0 | 15 |
| Footbridge | 0 | 0 | 0 | 16 | 0 | 0 | 1 | 0 | 0.06 | 17 |
| Walking | 0 | 0 | 0 | 0 | 32 | 0 | 0 | 0.06 | 0 | 32 |
| Stationary | 0 | 0 | 0 | 0 | 0 | 15 | 0 | 0 | 0 | 15 |
| Crosswalk | 0 | 0 | 0 | 0 | 0 | 0 | 10 | 0.1 | 0 | 10 |
| Overall | | | | | | | | 0.02 | 0.03 | 116 |

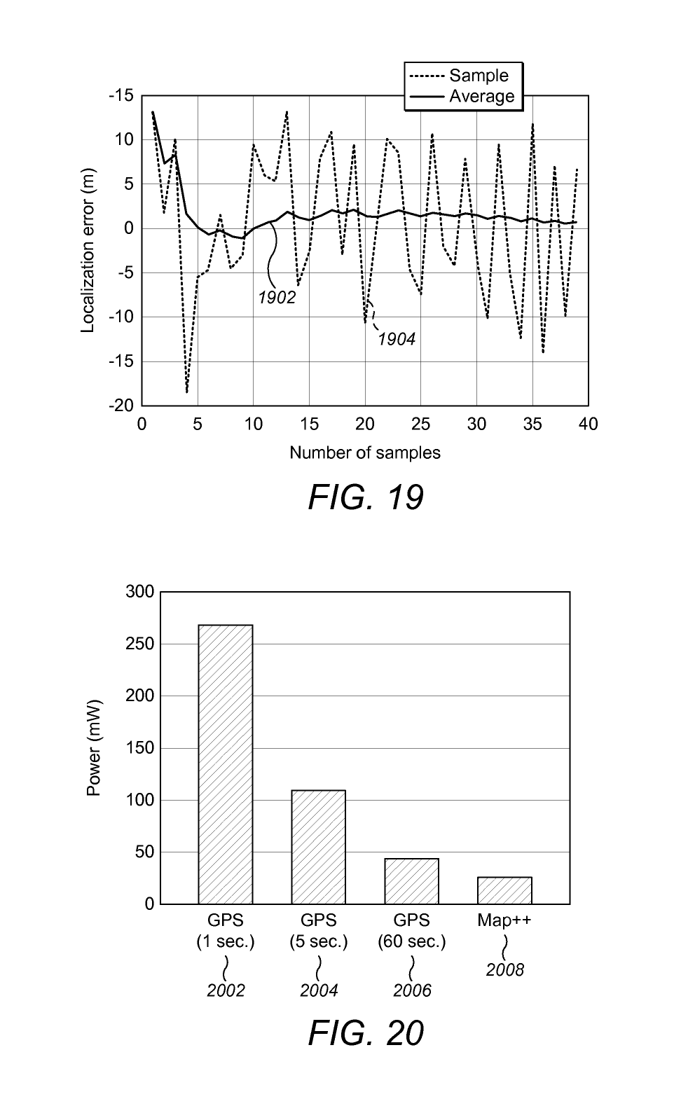

Discovered Semantic Road Features Location Accuracy: FIG. 19 shows the effect of number of samples on the accuracy of estimating the semantic location. We can see that the errors in the location of the discovered map feature drop quickly as we increase the number of crowd-sensed samples. We can consistently reach an accuracy of less than 2 m using as few as 12 samples for all discovered map features.

Power Consumption: FIG. 20 shows the power consumption of Map++, which is based on the inertial sensors for both road semantic detection and localization based on Dejavu, as compared to systems that detects the missing road segments only, based on the GPS traces with different duty-cycles. The power is calculated using the PowerTutor profiler and the android APIs using the HTC Nexus One cell phone. FIG. 20 shows that Map++ has a significantly lower energy profile 2008 compared to systems that are based on the GPS chip. GPS with 1 sec duty cycle 2002 has the largest power consumption, followed by 5 sec duty cycle 2004, and 60 sec duty cycle 2006.

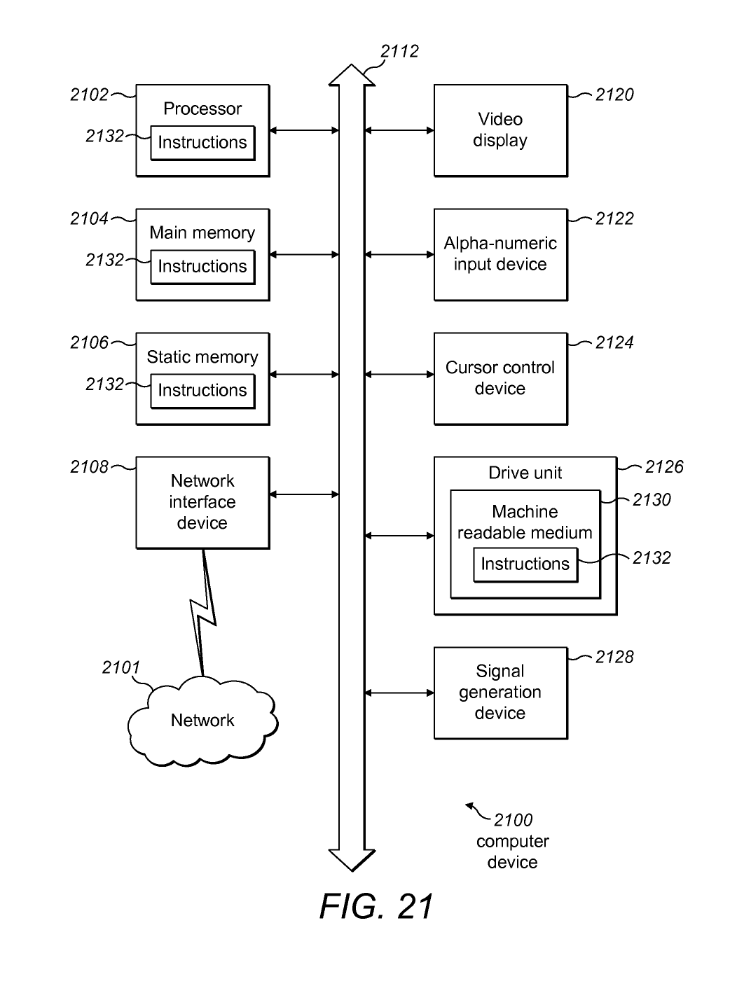

FIG. 21 is a diagrammatic system view 2100 of a computer device view in which any of the embodiments disclosed herein may be performed, according to one embodiment. Particularly, the computer system view 2100 illustrates a processor 2102, a main memory 2104, a static memory 2106, a bus 2112, a video display 2120, an alpha-numeric input device 2122, a cursor control device 2124, a drive unit 2126, a signal generation device 2128, a network interface device 2108, a machine readable medium 2130, instructions 2132, and a network 2101, according to one embodiment.

The computer system view 2100 may indicate a personal computer and/or a data processing system (e.g., server) in which one or more operations disclosed herein are performed. The processor 2102 may be microprocessor, a state machine, an application specific integrated circuit, a field programmable gate array, etc. The main memory 2104 may be a dynamic random access memory and/or a primary memory of a computer system. The static memory 2106 may be a hard drive, a flash drive, and/or other memory information associated with the computer system. The bus 2112 may be an interconnection between various circuits and/or structures of the computer system. The video display 2120 may provide graphical representation of information on the data processing system. The alpha-numeric input device 2122 may be a keypad, keyboard and/or any other input device of text (e.g., a special device to aid the physically handicapped). The cursor control device 2124 may be a pointing device such as a mouse.

The drive unit 2126 may be a hard drive, a storage system, and/or other longer term storage subsystem. The signal generation device 2128 may be a bios and/or a functional operating system of the data processing system. The network interface device 2108 may be a device that may perform interface functions such as code conversion, protocol conversion and/or buffering required for communication to and from a network 2101. The machine readable medium 2130 may provide instructions on which any of the methods disclosed herein may be performed. The instructions 2132 may provide source code and/or data code to the processor 2102 to enable any one/or more operations disclosed herein.

The instant system, method and process enables the right information at the right time to be intelligently and securely updated, maintained, and recombined dynamically across databases and delivery channels. The constraints and rules may be implemented in compliance to any user/users organization. The system, method and process eliminate information senescence and mutation, ensuring that internal and external user/customer gets the information they need to achieve their objectives. Even though the software is platform agnostic the display also is platform agnostic. The additional security enables the user of different professions to be comfortable to use it on any device including mobile devices.

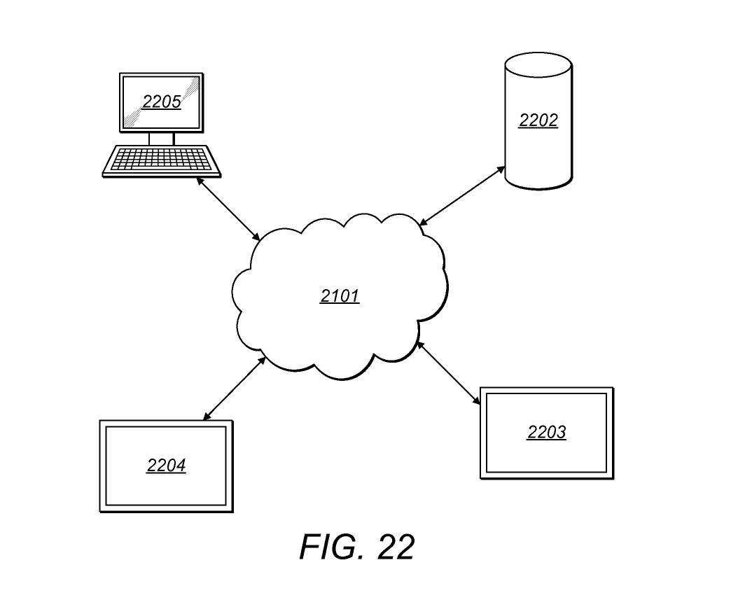

FIG. 22 is a systematic view of an integrated system for data management 2100 illustrating communication between user and the server through a network, according to one embodiment. In one embodiment a user or multiple users may connect to the server that hosts the multimedia tool in the system. In another embodiment, the user hard ware such as a PDA, mobile device such as tablets etc., computer or a mobile phone or any wireless device, or an electronic book (e-book) may be connected with each other or work independently to allow the user to use the multimedia tool for education, learning, and/or interactively playing games. The network 2101 may be a LAN, WAN, mobile, telecommunications, internet, intranet, WiFi and/or ZigBee network, etc. The user/individual 2205, 2204 and 2203, a database 2202 to store all the information and so on may be an individual, a parent, a scientist, an author, but not limited to these group of folks only. The user and individual are used interchangeably and mean the same. The user may be any person who accesses the data management system for various activities as discussed in different case scenarios in the supporting figures. The cloud server may also be used for storing data and processing. The data management tool may be accessed to search, create content, upload content, view content, use the content and save and/or delete the content. The server may be stand alone, cloud based or hosted services.

In this disclosure Map++: a system for automatically enriching digital maps via a crowdsensing approach based on standard cell phones is explained. For energy efficiency, Map++ uses only low-energy sensors and sensors that are already running for other purposes. We also disclose the Map++ architecture as well as the features and classifiers that can accurately detect the different road features such as tunnels, bridges, crosswalks, stairs, and footbridges from the user traces. In this document, we showed the evidence through measurements how useful traffic and road features can be added to real-world maps. Map++ has a significantly lower energy profile compared to systems that are based on GPS.

### INDUSTRIAL APPLICABILITY

Accordingly, the specification and drawings are to be regarded in an illustrative rather than a restrictive sense. The instant disclosure is valid for cell phone networks and general wireless network that works under IEEE 802.11 a/b/g/n/ac standards. The instant disclosure works with all smart phones that are equipped with standard sensors including GPS. The instant disclosure does not require any special permission to be generated on the smart devices. The hall mark of the instant disclosure is that the innovation works seamlessly and silently in the background without any disturbance to the smart device owners to carry on the sensor data and updating the maps. The instant disclosure is directly applicable to industry as majority of the smart devices have WiFi interfaces and can be used immediately. The procedure works well with smart devices. The instant disclosure is directly applicable to the map industry where accurate maps are needed at ground level for people to move about and those with disability.

What is claimed is:

1. A method, comprising:
collecting at least one of a trace information data, a location information using a geo positioning system (GPS) data and sensor data that is time stamped as raw data;
preprocessing the raw data using a low-pass filter to the raw data to reduce the effect of phone orientation changes and noise and bogus changes, wherein the noise and bogus changes are one of a sudden breaks used by a vehicle, small changes in the direction while moving and mobile coordinate;
detecting a mode of transportation to collect a transportation data, wherein the mode of transportation is at least one of a vehicle and people who are walking;
extracting a map semantics data as a unique identifier by the semantic detection module; and
clustering the preprocessed raw data, transportation data and map semantics data to automatically map, direct and update using a crowd sensing mechanism from a mobile device for automatic semantic identification.

2. The method of claim 1, wherein the trace information data is at least one of an inertial sensor and cellular network information.

3. The method of claim 1, wherein the low pass filtering uses a Z axis and Y axis changes in a vehicle motion data.

4. The method of claim 1, further comprising:
collecting a finer data for the finer details of the path to be shown in maps, such as escalators, steps, and pedestrian bridge using sensors available in smart phones using crowd sensing approach of the people who are walking.

5. The method of claim 4, further comprising:
analyzing the details of the path for traffic calming, bridges, tunnels, turns, curves, and roundabouts using sensors in smart phones of people who are in-vehicles.

6. The method of claim 5, further comprising:
using a mobile phone sensor that are already activated for various purposes than GPS specific sensors, thus consuming less energy for data collection.

7. The method of claim 6, further comprising:
implementing the method on a dedicated hardware for portability purposes.

8. The method of claim 6, further comprising:
implementing the method as an add-on app in smart phones or computers for travel planning purposes.

9. A system, comprising:
a processor to house and compute various modules;
a trace information data collection module to collect information for a specific location as a time stamped and location stamped raw data;
a preprocessing module to gather and filter the raw data;
a transportation mode detection module for acquiring a high accuracy differentiated data between the different transportation modes using an energy-efficient inertial sensor; and
a semantic detection module performs a clustering algorithm to detect, map and update a precise map location for a vehicular traffic and pedestrian traffic.

10. The system of claim 9, further comprising:
a vehicular deflection device to calculate a Z axis and Y axis changes in a vehicle motion.

11. The system of claim 10, further comprising:
a database to store all the data collected for precise map location.

12. The system of claim 11, further comprising:
a mobile phone sensor that are already activated for various purposes than GPS specific sensors, thus consuming less energy for data collection.

13. The system of claim 10, further comprising:
a Map++ architecture as well as the features and classifiers that can accurately detect the different road features such as underpasses, crosswalks, stairs, escalators, and footbridges from the user traces.

14. The system of claim 10, further comprising:
a network to support a mobile devices and a sensor to transfer data to different modules.
